(19) United States
(12) Patent Application Publication
(10) Pub. No.: US 2026/0366643 A1
(43) Pub. Date: Nov. 19, 2026

(54) PNEUMATIC SOLENOID VALVE, VEHICLE COMPRESSED AIR SYSTEM, AND VEHICLE

(71) Applicant: ZF CV Systems Europe BV, Brussels (BE)

(72) Inventor: Arian Roolfs, Hannover (DE)

(21) Appl. No.: 19/726,694

(22) Filed: Jun. 30, 2026

Related U.S. Application Data
(63) Continuation of application No. PCT/EP2024/085749, filed on Dec. 11, 2024.

(30) Foreign Application Priority Data
Jan. 24, 2024 (DE) 10 2024 101 950.6

(51) Int. Cl. F16K 31/06; B60T 13/68; F16K 24/04

(52) U.S. Cl. CPC F16K 31/0658; B60T 13/683; F16K 24/04; F16K 31/0693

(57) ABSTRACT

A pneumatic solenoid valve has an actuator unit with a coil, a magnetic core, an armature, a housing with a first connection forming a compressed air inlet, a second connection forming a compressed air outlet, and a chamber with a valve seat at the first connection. The valve seat is closeable via a sealing element on the armature. The actuator unit has an armature guide, in which the armature is translationally movable. The armature guide is movably mounted in the housing and connected to the core. The valve is configured to produce a first partial stroke of the armature, when the coil is energized, to lift the sealing element from the valve seat and to produce, via a compressed air flow flowing in at the first compressed air connection, a stroke movement of the armature guide and of the magnetic core, resulting in a second partial stroke of the armature.

### CROSS-REFERENCE TO RELATED APPLICATIONS

This application is a continuation application of international patent application PCT/EP2024/085749, filed Dec. 11, 2024, designating the United States and claiming priority from German application 10 2024 101 950.6, filed Jan. 24, 2024, and the entire content of both applications is incorporated herein by reference.

### TECHNICAL FIELD

The disclosure relates to a pneumatic solenoid valve, in particular for a compressed-air system of a vehicle. The disclosure furthermore relates to a vehicle compressed-air system having such a pneumatic solenoid valve, and to a vehicle having a compressed-air system which has such a pneumatic solenoid valve.

### BACKGROUND

DE 10 2011 078 102 A1 describes an electromagnetically actuated seat valve with a sealing element, with a movable magnet armature which interacts with the sealing element, and with an electrically energizable coil, wherein there is provided an additional stop for the magnet armature, against which the magnet armature abuts as long as the sealing element is in the closed position. In the closed position, the magnet armature abuts against the sealing element and thus produces the sealing effect.

### SUMMARY

A pneumatic solenoid valve, in particular for a compressed-air system of a vehicle, has an electromechanical actuator unit which has an energizable coil, has a magnet core and has a movable armature, having a valve housing which has a first compressed-air port, forming a compressed-air inlet, and has a second compressed-air port, forming a compressed-air outlet, and having a valve chamber which has a valve seat at the first compressed-air port, wherein the valve seat is able to be closed off via a sealing element arranged on the armature, wherein the electromechanical actuator unit has an armature guide in which the armature is movable in translation, wherein the armature guide is arranged movably in the valve housing and is connected to the magnet core, and wherein the pneumatic solenoid valve is configured to effect, when the coil is energized, a first partial lift of the armature for lifting the sealing element off from the valve seat, and, by way of a compressed-air stream flowing in at the first compressed-air port, a lifting movement of the armature guide and the magnet core with a resulting second partial lift of the armature.

In other words, what is proposed is a solenoid valve in which, by way of a movable armature guide, an electromagnetically effected lifting movement of the armature is able to be assisted pneumatically by a compressed-air stream in order to increase an effective opening of the solenoid valve.

The proposed pneumatic solenoid valve has the advantage that a self-energizing solenoid valve in which, with small electromagnetic forces, relatively large lifting movements are able to be generated and large opening widths of the solenoid valve are able to be realized is provided. The efficiency and performance of the solenoid valve are increased by the pneumatic self-energizing. The solenoid valve is effectively operable with small electric currents and, accordingly, with a low electrical energy requirement. In comparison with conventional solenoid valves, a smaller electromagnetic force is required for the same effective opening or a larger effective opening can be achieved with a comparable electromagnetic force. The compressed-air stream used for assisting the actuation of the solenoid valve is in any case present as a working fluid to be controlled and does not have to be provided separately. The proposed pneumatic solenoid valve moreover has a simple and robust construction.

A pneumatic solenoid valve may be understood as meaning an electromagnetically actuatable valve for controlling compressed-air streams. The pneumatic solenoid valve can be configured for selectively opening up and blocking off compressed-air lines. The pneumatic solenoid valve may be configured as a seat valve, that is, as a valve in which the compressed-air ports are able to be connected or disconnected by placing and lifting off a sealing element onto or from a valve seat.

Vehicles, in particular utility vehicles, may have compressed-air systems which may be configured for example as pneumatic compressed-air systems, such as pneumatic braking systems, transmission automation systems or as air suspension systems. Pneumatic solenoid valves may be used in such compressed-air systems, for example for opening up and blocking off compressed-air lines. Moreover, use of the solenoid valve as a venting valve for venting a compressed-air line into vehicle surroundings or use of the solenoid valve as an aeration valve for aerating a diaphragm cylinder are also conceivable, for example. Owing to their fast response behavior, solenoid valves have advantages when used in pneumatic compressed-air systems that require a short reaction time, although solenoid valves can have a high requirement in terms of current in the case of relatively large armature lifts for realizing large opening widths. Consequently, their use in mobile devices such as vehicles can be limited. With the proposed solenoid valve, whose armature lift is able to be assisted pneumatically by a compressed-air stream entering the solenoid valve, the use of solenoid valves in vehicles can advantageously be extended and optimized.

An electromechanical actuator unit may be regarded as an assembly of the solenoid valve for converting electrical energy into mechanical energy. The electromechanical actuator unit has an energizable coil, a magnet core and a movable armature. Furthermore, the magnet core may be arranged movably in the valve housing of the solenoid valve in order to be able to realize the second partial-lift movement of the armature (described in more detail below) in the case of which the magnet core together with the armature guide and the electromagnetically attracted armature are jointly raised. The coil may surround the magnet core. Energization of the coil makes it possible to generate an electromagnetic field that is guided and amplified by the magnet core. The electromagnetic field exerts a magnetic attractive force on the movable armature so that the latter is displaced in the direction of the magnet core. If the coil is no longer energized, there is no longer an electromagnetic field and the movable armature is displaced, for example assisted by spring force, back into its initial position. Accordingly, activation of the actuator unit for displacing the armature into an open position can be performable through energization of the coil and deactivation of the actuator unit for displacing the armature into a closed position can be performable through deenergization of the coil, so that the solenoid valve can be configured as a normally closed solenoid valve.

The valve housing has a first compressed-air port and a second compressed-air port. The first compressed-air port is provided as a compressed-air inlet, and the second compressed-air port is provided as a compressed-air outlet. During operation of the solenoid valve, there is provided a higher pressure at the compressed-air inlet than at the compressed-air outlet, so that a compressed-air stream through the solenoid valve in an actuated state of the solenoid valve is directed from the compressed-air inlet to the compressed-air outlet. According to different embodiments, the solenoid valve can be configured for a working pressure at the second compressed-air port that is equal to or greater than atmospheric pressure. The valve seat of the solenoid valve, which valve seat is able to be closed off via a sealing element fastened to the armature, is arranged at the first compressed-air port, in particular at its region that opens out into the valve chamber.

A valve chamber is to be understood as meaning a cavity in the valve housing of the solenoid valve that is able to be flowed through by compressed air and that is configured for a fluidic connection of the first compressed-air port to the second compressed-air port. The solenoid valve may have further cavities, for example a receiving space (discussed in more detail below) for receiving the magnet core during the displacement thereof.

The electromechanical actuator unit has an armature guide in which the armature is movable in translation. The armature guide may be for example a housing-like guide component which radially surrounds the armature and in whose interior space the armature is displaceable in translation in a defined manner on an inner-wall surface of the armature guide. The armature guide is arranged in the valve housing so as to be movable in translation in particular and can be raised by a compressed-air stream flowing into the valve chamber and lowered again, in particular assisted by spring force, when there is a pressure drop. The armature guide is connected, for example in a materially bonded and/or form-fitting manner, to the magnet core so that a movement of the armature guide is directly transmissible to the magnet core and a displacement of the armature guide can result in a displacement of the magnet core. Owing to a pneumatically generatable movement of the armature guide via a compressed-air stream flowing in at the first compressed-air port, the armature of the electromagnetic actuator unit, which armature is able to be attracted electromagnetically by the magnet core, is movable not only through energization of the coil but additionally, in its attracted state, through the movement of the magnet core in interaction with the armature guide. Consequently, the lifting movement of the armature can be increased without an additional electrical energy requirement and an opening width of the solenoid valve in the valve chamber can be increased.

The pneumatic solenoid valve is configured to effect, when the coil is energized, a first partial lift of the armature for lifting the sealing element off from the valve seat. The first partial lift may be small in relation to an inlet diameter of the first compressed-air port at the valve chamber. For example, the inlet diameter may be at least twice, at least five times or at least ten times as large as the extent of the first partial lift. The compressed-air stream flowing in as a result of the lifting-off of the sealing element leads to a build-up of pressure in or on the armature guide, which, upon exceedance of a structurally predefinable minimum pressure, results in a displacement of the armature guide and the magnet core connected thereto with a resulting second partial lift of the armature, which is attracted electromagnetically by the magnet core. The first partial lift and the second partial lift of the armature may result in an overall lift of the armature which may correspond to a maximum opening width of the solenoid valve between the valve seat and the sealing element.

The solenoid valve may furthermore be configured, when the coil is de-energized, owing to the absence of an electromagnetic field, to firstly displace the armature with the sealing element back in the direction of the valve seat, in particular with spring-force assistance, before pressure equalization in relation to the valve chamber and the armature guide is realized via the second compressed-air port, so that, owing to the associated pressure drop, the armature guide is able to be displaced, in particular with spring-force assistance, back into its initial position.

According to an embodiment, the pneumatic solenoid valve may be configured in such a way that the second partial lift, able to be effected via the compressed-air stream flowing in at the first compressed-air port, of the armature is larger than the first partial lift, able to be effected via energization of the coil, of the armature. For example, the second partial lift may be at least twice or at least three times as large as the first partial lift. Accordingly, the second partial lift can provide a main portion of the opening movement and the force acting pneumatically on the armature guide can have a greater lifting effect on the armature than the electromagnetic force. Accordingly, in the case of the proposed embodiment, the second partial lift may be regarded as the main lift of the armature, this being generated pneumatically and thus reducing the requirement in terms of current of the solenoid valve for the actuation thereof.

According to an embodiment, the armature guide may be configured, in an initial position, to be seated on a valve-housing surface which surrounds the valve seat and to receive the inflowing compressed-air stream in an inner volume of the armature guide. An initial position of the armature guide may refer to a closed state of the solenoid valve in which the coil is not energized and the sealing element of the armature closes off the valve seat. The armature guide may be formed to be open in the direction of the valve-housing surface that surrounds the valve seat. The armature guide may have a cross-sectional widening in the region of the valve chamber, so that the armature is spaced apart from an inner-wall surface of the armature guide in the region of the valve chamber. A compressed-air stream flowing in when the sealing element is lifted off by a first partial lift of the armature can accordingly flow into an interior space of the armature guide and displace the armature guide in the direction of the magnet core via a pressure force acting on an inner-wall surface of the armature guide. Owing to the fact that the armature guide is firstly filled with the inflowing compressed-air stream for a build-up of pressure before, upon attainment of a structurally predefined minimum pressure, a lifting movement of the armature guide is realized, the inflowing compressed-air stream cannot flow away to the second compressed-air port during the build-up of pressure. Accordingly, according to the embodiment described, blocking of the second compressed-air port by the wall of the armature guide until attainment of the desired minimum pressure can be ensured and a rapid build-up of pressure for displacing the armature guide can be made possible.

According to an embodiment, the valve seat may be raised in relation to a plane of the valve-housing surface surrounding the valve seat. For example, the valve seat may rise conically from the plane of the valve-housing surface. By way of a raised valve seat, targeted air-flow guidance of the compressed-air stream flowing into the valve chamber or into the armature guide for effecting the second partial lift of the armature can be promoted. Consequently, the build-up of pressure on or in the armature guide that is required for this purpose is promoted and an outflow of compressed air to the second compressed-air port is reliably avoided.

According to an embodiment, the pneumatic solenoid valve may be configured as a 2/2-way valve. In this way, a solenoid valve having a simple construction, an inexpensive production and high efficiency may be provided. As a 2/2-way valve, the pneumatic solenoid valve may have exactly one compressed-air inlet and one compressed-air outlet and an open and a closed switching state.

According to an embodiment, the pneumatic solenoid valve may have a restoring element for resetting the magnet core and the armature guide. In this way, simple and efficient resetting of the magnet core and the armature guide for closing the solenoid valve can be made possible. The restoring element may be arranged for example on a side of the magnet core that is remote from the armature. Furthermore, the restoring element can act as a preload element on the magnet core and the armature guide connected thereto and promote seating in a sealing manner of the armature guide on the valve-housing surface via spring force. The resetting element may be for example a compression spring which acts on the magnet core and which, owing to the connection between the magnet core and the armature guide, additionally acts on the armature guide via the magnet core. As a result of the pressure force on the magnet core and the armature guide, these are able to be displaced quickly into their respective initial position via spring-force assistance when the coil is de-energized.

According to an embodiment, the pneumatic solenoid valve may have a restoring device which is arranged in the armature guide and which serves for resetting the armature. This allows resetting of the armature to be assisted efficiently when the coil is de-energized. Furthermore, the restoring device can act as a preload element on the armature and the sealing element and promote seating in a sealing manner of the sealing element on the valve seat via spring force. The restoring device may be for example a compression spring which acts on the armature. The compression spring may, for example, be wound around the armature and be supported against an inner-wall surface or a projection of the armature guide.

According to an embodiment, a receiving space for receiving the magnet core during a lifting movement of the armature guide and the magnet core may be arranged on a side of the magnet core that is remote from the armature. The receiving space may be a cavity into which the magnet core is displaceable during a lifting movement, so that its movement in translation in the valve housing is made possible or facilitated. Furthermore, the above-described restoring element for resetting the magnet core and the armature guide may be arranged in the receiving space. The receiving space may form a counterpart volume in relation to the valve chamber.

According to an embodiment, the receiving space may be connected by way of a venting opening to the atmosphere. A solenoid valve according to this embodiment may be usable in particular for applications in which a working pressure corresponding substantially to atmospheric pressure prevails at the second pressure port. For example, such a solenoid valve may be configured as a venting valve. Due to the receiving space connected to a venting opening, an air volume present in the receiving space can be displaced during an upward movement of the magnet core and the armature guide in the valve housing, so that the displacement of the magnet core and the armature guide is facilitated and pressure equalization during movements of the magnet core and the armature guide is possible. Moreover, a simple build-up of pressure in the solenoid valve is made possible. By contrast to embodiments in which the magnet core has a central bore (as will be explained in more detail below), the embodiment described here is moreover associated with a simple construction of the magnet core.

According to an alternative embodiment, the receiving space may be closed and the magnet core may have a continuous central bore. A solenoid valve according to this embodiment may be usable in particular for applications in which a working pressure above atmospheric pressure prevails at the second pressure port. Due to the closed receiving space, during a lifting movement of the magnet core, a build-up of pressure in the receiving space that promotes a movement of the armature guide and the magnet core by way of the pressure equalization via the central bore of the magnet core when the coil is subsequently deenergized can be made possible. According to a embodiment of the embodiment, the receiving space may have a channel-like volume extension running in the direction of movement of the magnet core, wherein the receiving space may transition into the volume extension with a cross-sectional reduction. By way of a volume extension, an excessive build-up of pressure during a lifting movement of the magnet core, which could counteract the movement, can be avoided.

According to an embodiment, a receiving chamber for receiving the armature guide during a lifting movement of the armature guide and of the magnet core may be arranged adjoining the valve chamber. In this way, a separate cavity for receiving the raised armature guide is provided. The receiving chamber may be formed by a chamber extension of the valve chamber that is dimensioned in a manner matching the armature guide. If the armature guide has a cross-sectional widening of stepped form, for example, the receiving chamber may have a stop for limiting a lifting movement of the armature guide in the region of its stepped cross-sectional widening. In addition, the armature guide may have a sealing means, for example a sealing ring, for sealing off the receiving chamber in relation to the valve chamber.

The disclosure also relates to a vehicle compressed-air system having a pneumatic solenoid valve according to one of the above-described features. The vehicle compressed-air system may form for example a pneumatic compressed-air system, such as a pneumatic braking system, a transmission automation system or an air suspension system. The pneumatic solenoid valve may in this case be configured for selectively releasing and blocking compressed-air streams. According to embodiments, the pneumatic solenoid valve may be configured as a venting valve or as an aeration valve for venting or aerating a diaphragm cylinder. The proposed vehicle compressed-air system has inter alia the advantage of being able to realize effective control even of relatively large compressed-air streams with low electrical energy expenditure using the described pneumatic solenoid valve, so that the vehicle compressed-air system can be operated efficiently and with high performance. Owing to the simple and robust construction of the pneumatic solenoid valve, the proposed vehicle compressed-air system is moreover associated with low manufacturing and maintenance outlay.

The disclosure also relates to a vehicle having a compressed-air system which has a pneumatic solenoid valve according to one of the above-described features. The vehicle may in particular be a utility vehicle, for example a towing vehicle such as a tractor unit or a trailer vehicle such as a semitrailer. Utility vehicles may, owing to their transporting tasks, have pneumatic compressed-air systems with a high compressed-air requirement and high requirements for the response times of the pneumatic components, so that, for a vehicle having a compressed-air system which has a pneumatic solenoid valve according to one of the above-described features, it is possible to achieve an enhanced beneficial effect with regard to the realization of large compressed-air streams with low energy consumption. In principle, however, it is also conceivable for the vehicle to be in the form of a passenger motor vehicle having a compressed-air system, such as for example an air suspension system, that may advantageously have a pneumatic solenoid valve according to the proposed features.

### BRIEF DESCRIPTION OF DRAWINGS

The invention will now be described with reference to the drawings wherein:

FIGS. 1A to 1D show sectional illustrations of a pneumatic solenoid valve according to a first embodiment in various states during the activation and deactivation of the solenoid valve;

FIGS. 2A to 2D show sectional illustrations of a pneumatic solenoid valve according to a second embodiment in various states during the activation and deactivation of the solenoid valve; and,

FIG. 3 shows a schematic diagram of a vehicle with a compressed-air system having a pneumatic solenoid valve in a side view.

### DETAILED DESCRIPTION

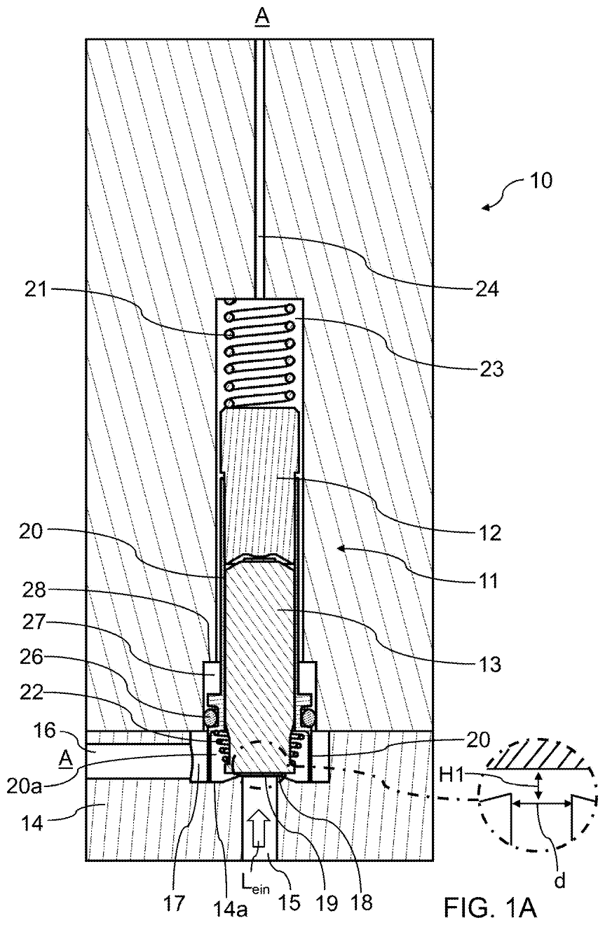

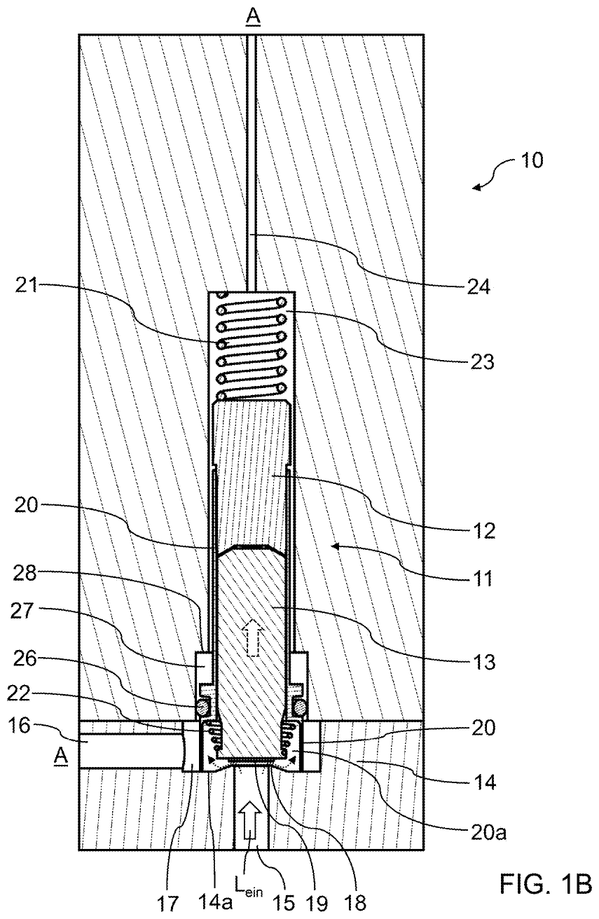

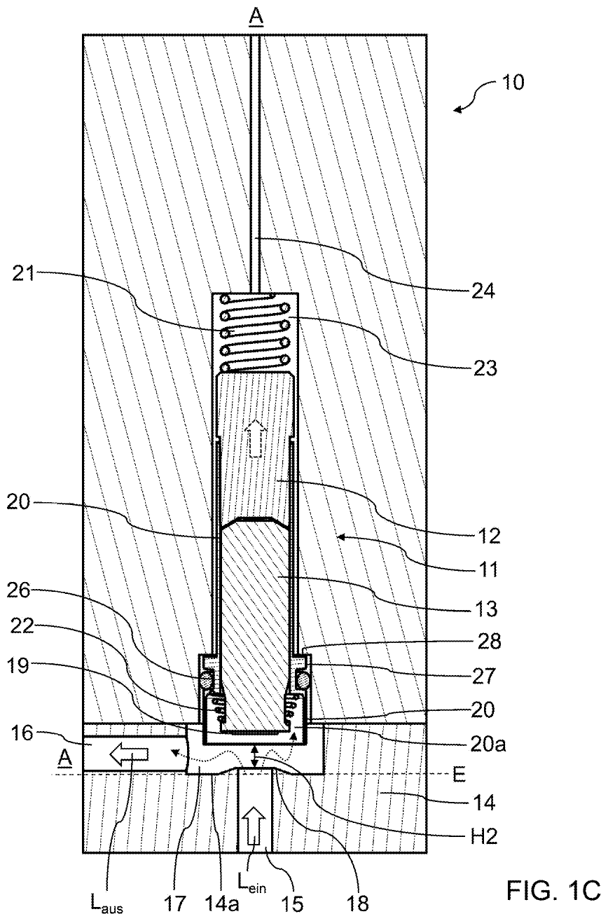

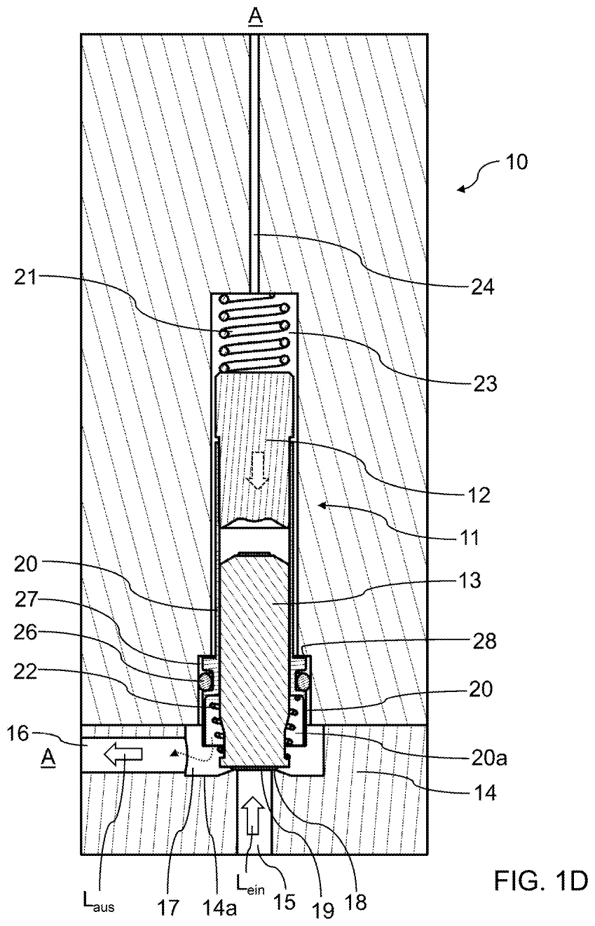

FIGS. 1A to 1D show, in each case in a sectional view, a pneumatic solenoid valve 10 according to a first embodiment. The pneumatic solenoid valve 10, which is normally closed according to the embodiment shown, is configured for controlling compressed-air streams and is configured as a seat valve. The pneumatic solenoid valve 10 has an electromechanical actuator unit 11 with a magnet core 12, with a movable armature 13 and with an energizable coil (not illustrated in any more detail for reasons of clarity). The energizable coil may surround the magnet core 12 and be configured to generate an electromagnetic field when energized. The magnet core 12 is arranged movably in the valve housing 14.

The pneumatic solenoid valve 10 furthermore has a valve housing 14 with a first compressed-air port 15 and with a second compressed-air port 16, wherein the first compressed-air port 15 forms a compressed-air inlet and the second compressed-air port 16 forms a compressed-air outlet. A compressed-air stream flowing through the solenoid valve 10 can enter at the compressed-air inlet as an inflowing compressed-air stream Lₑᵢₙ and exit via the compressed-air outlet as an outflowing compressed-air stream Lₐᵤₛ. The pneumatic solenoid valve 10 furthermore has a valve chamber 17 with a valve seat 18 at the first compressed-air port 15, wherein the valve seat 18 is able to be closed off via a sealing element 19 arranged on the armature 13. The valve chamber 17 is configured to establish a fluidic connection between the first compressed-air port 15 and the second compressed-air port 16 in an open state of the pneumatic solenoid valve 10.

In addition to the energizable coil, the magnet core 12 and the movable armature 13, the electromechanical actuator unit 11 has an armature guide 20 in which the armature 13 is movable in translation. The armature guide 20 radially surrounds the armature 13, wherein the armature 13 is displaceable in translation in a defined manner on an inner-wall surface of the armature guide 20. The armature guide 20 is connected to the magnet core 12 and is configured to be movable in the valve housing 14, in particular in the region of the valve chamber 17. In particular, the armature guide 20 may be configured for a translational movement in the valve housing 14, which movement, owing to the connection between the armature guide 20 and the magnet core 12, is transmissible to the magnet core 12 and to the armature 13, the armature being attracted electromagnetically when the pneumatic solenoid valve 10 is activated.

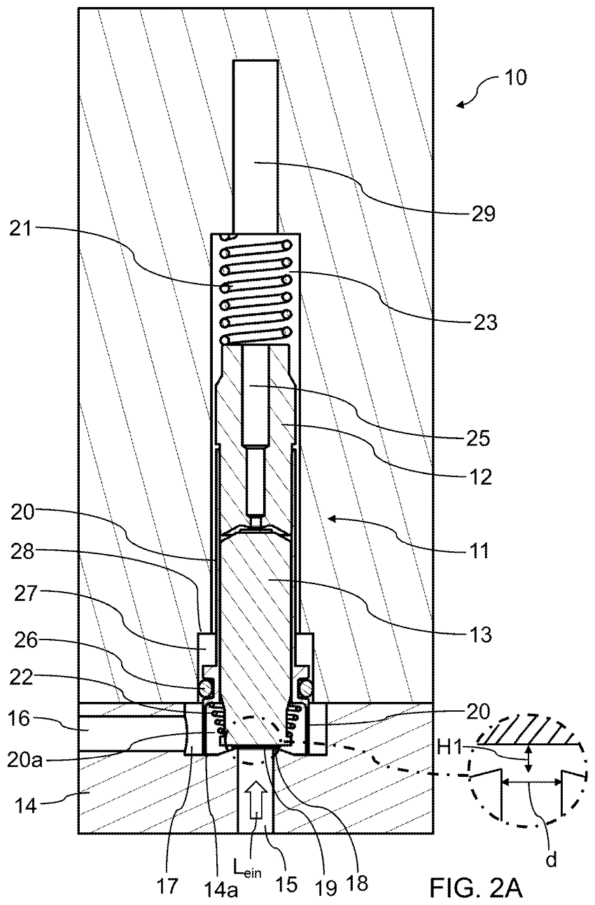

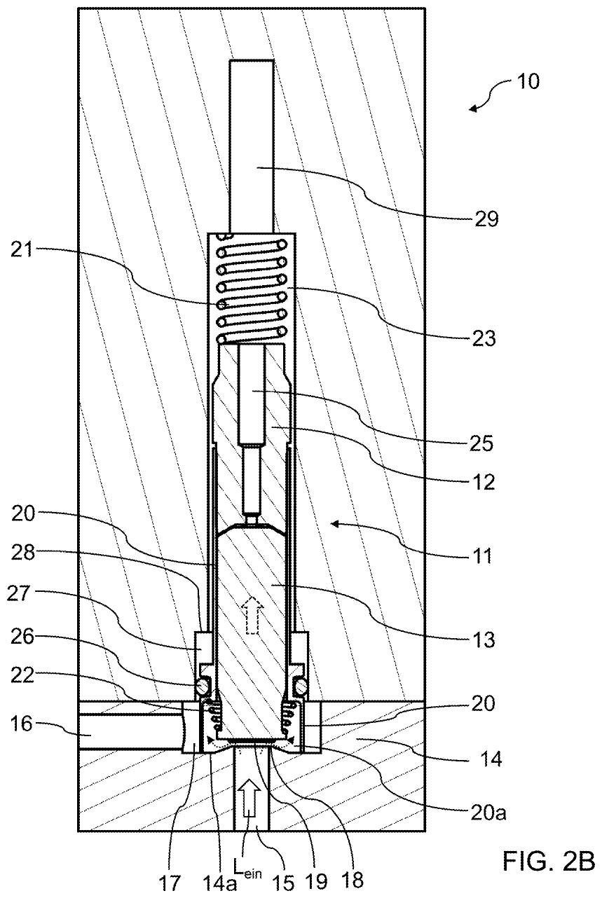

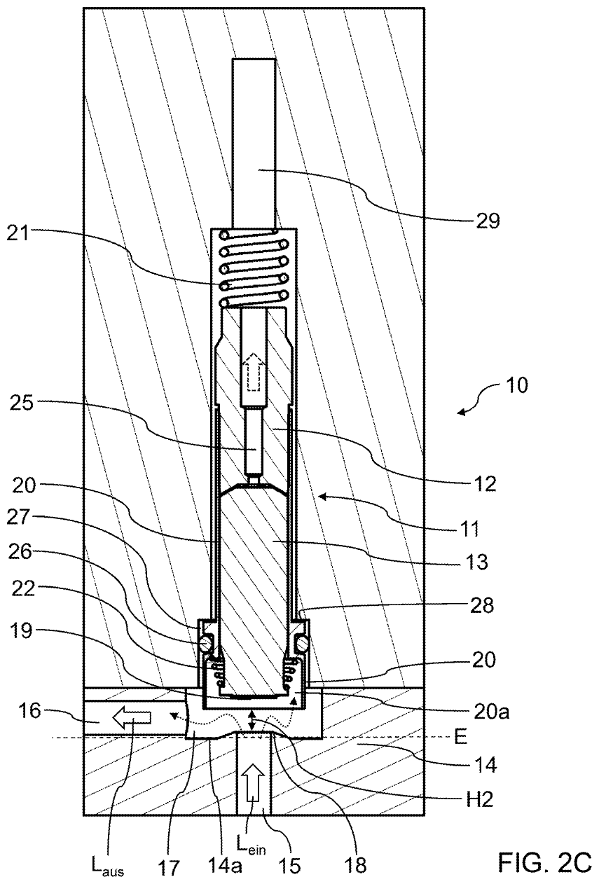

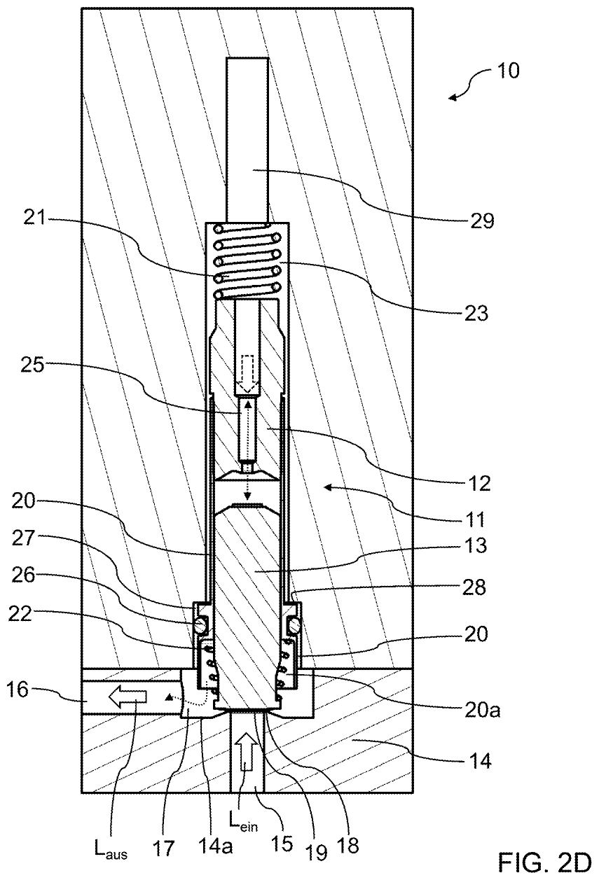

As is illustrated on the basis of FIGS. 1A to 1D and FIGS. 2A to 2D, the pneumatic solenoid valve 10 is configured to effect, when the coil is energized, a first partial lift H1 of the armature 13 for lifting the sealing element 19 off from the valve seat 18, the first partial lift being visible for example in FIGS. 1A and 2A, and, by way of a compressed-air stream Lₑᵢₙ flowing in at the first compressed-air port 15, a lifting movement of the armature guide 20 and the magnet core 12 with a resulting second partial lift H2 of the armature 13, the second partial lift being visible for example in FIGS. 1C and 2C. In this way, a self-energizing pneumatic solenoid valve 10 with high efficiency and performance is provided. The pneumatic solenoid valve 10 is operable with small electric currents, wherein an increased effective opening of the solenoid valve 10 is achievable by way of the pneumatic assistance. Moreover, the pneumatic solenoid valve 10 has a simple and robust construction.

According to the shown embodiments in FIGS. 1A to 1D and FIGS. 2A to 2D, the second partial lift H2, able to be effected via the compressed-air stream Lₑᵢₙ flowing in at the first compressed-air port 15, of the armature 13 is larger than the first partial lift H1, able to be effected via energization of the coil, of the armature 13, for example at least three times as large. In this way, the second partial lift H2 may be regarded as the main lift of the armature 13, this being generated pneumatically and thus reducing the requirement in terms of current of the solenoid valve 10 for the actuation thereof. Moreover, the first partial lift H1 may be small in relation to an inlet diameter d of the first compressed-air port 15 at the valve chamber 17. For example, the inlet diameter d may be at least twice, at least five times or at least ten times as large as the extent of the first partial lift H1. Furthermore, the armature guide 20 according to the illustrated first and second embodiment is configured, in an initial position, to be seated on a valve-housing surface 14a which surrounds the valve seat 18 and to receive the inflowing compressed-air stream Lₑᵢₙ in an inner volume 20a of the armature guide 20. The armature guide 20 is formed to be open in the direction of the valve-housing surface 14a that surrounds the valve seat 18, and has a cross-sectional widening in the region of the valve chamber 17. A compressed-air stream Lₑᵢₙ flowing in when the sealing element 19 is lifted off by a first partial lift H1 of the armature 13 can flow into the inner volume 20a of the armature guide 20 and displace the armature guide 20 via a pressure force acting on an inner-wall surface of the armature guide 20.

FIGS. 1C and 2C show that the valve seat 18 is raised in relation to a plane E of the valve-housing surface 14 a surrounding the valve seat 18, so that targeted air-stream guidance in the direction of the inner volume 20a of the armature guide 20 is achievable. Furthermore, as FIGS. 1A to 1D and FIGS. 2A to 2D show, the illustrated pneumatic solenoid valve 10 according to the first and second embodiment is configured as a 2/2-way valve, so that exactly one compressed-air inlet and one compressed-air outlet and an open and a closed switching state of the correspondingly simply and robustly constructed solenoid valve 10 are provided.

As can be seen in FIGS. 1A to 1D and FIGS. 2A to 2D, the pneumatic solenoid valve 10 has a restoring element 21 which is configured as a compression spring and which serves for resetting the magnet core 12 and the armature guide 20. The restoring element 21 is arranged on a side of the magnet core 12 remote from the armature 13 and allows efficient, spring-force-assisted resetting of the magnet core 12 and the armature guide 20 when the solenoid valve 10 is closed. Furthermore, the pneumatic solenoid valve 10 has a restoring device 22, which is configured as a compression spring, which is arranged in the armature guide 20, which serves for resetting the armature 13 and by way of which resetting of the armature 13 is able to be assisted efficiently by spring force when the coil is de-energized. In this case, the compression spring is wound around the armature 13 and is supported against a projection of the armature guide 20.

In the pneumatic solenoid valve 10 according to the first and second embodiments, a receiving space 23 for receiving the magnet core 12 during a lifting movement of the armature guide 20 and the magnet core 12 is arranged on a side of the magnet core 12 that is remote from the armature 13. The magnet core 12 is displaceable into the receiving space 23 when the armature guide 20 is moved in translation. Furthermore, the restoring element 21 is arranged in the receiving space 23.

As FIGS. 1A to 1D show, according to the first embodiment of the pneumatic solenoid valve 10, it is provided that the receiving space 23 is connected by way of a venting opening 24 to the atmosphere A surrounding the pneumatic solenoid valve 10. The pneumatic solenoid valve 10 according to the first embodiment is consequently usable in particular for applications in which a working pressure corresponding substantially to atmospheric pressure prevails at the second pressure port 16. The solenoid valve 10 according to the first embodiment may be usable for example as a venting valve. Due to the receiving space 23 connected to a venting opening 24, an air volume present in the receiving space 23 can be displaced during an upward movement of the magnet core 12 and the armature guide 20 in the valve housing 14, so that the displacement of the magnet core 12 and the armature guide 20 is facilitated and pressure equalization during movements of the magnet core 12 and the armature guide 20 is made possible. Moreover, a simple build-up of pressure in the solenoid valve 10 is made possible.

Furthermore, it can be seen in FIGS. 1A to 1D and in FIGS. 2A to 2D that, according to the embodiments shown, a receiving chamber 27 for receiving the armature guide 20 during a lifting movement of the armature guide 20 and of the magnet core 12 is arranged adjoining the valve chamber 17. In this way, a separate cavity for receiving the raised armature guide 20 is provided. The armature guide 20 furthermore has a stepped cross-sectional widening which can abut against a stop 28 of the receiving chamber 27, so that the lifting movement of the armature guide 20 is limited in a structurally defined manner. Moreover, the armature guide 20 has a sealing ring 26 for sealing off the receiving chamber 27 in relation to the valve chamber 17.

The functioning of the pneumatic solenoid valve 10 according to the first embodiment will be explained in more detail below on the basis of the different states of the pneumatic solenoid valve 10 during activation and deactivation thereof that are shown in FIGS. 1A to 1D.

In FIG. 1A, the coil of the electromechanical actuator unit 11 is energized. Consequently, the armature 13 is attracted electromagnetically by the magnet core 12 and undergoes a first partial lift H1, which results in the sealing element 19 being lifted off from the valve seat 18, so that compressed air present at the first compressed-air port 15 can flow in as an inflowing compressed-air stream Lₑᵢₙ. It can be seen in FIG. 1B that the inflowing compressed-air stream Lₑᵢₙ increasingly fills an inner volume 20a of the armature guide 20, so that a build-up of pressure is realized. If the increasing pressure in the armature guide 20 exceeds a structurally predefinable minimum pressure, the armature guide 20, as shown in FIG. 1C, is raised and displaced into the receiving chamber 27. Owing to the magnet core 12 connected to the armature guide 20, the magnet core is also raised and is displaced into the receiving space 21. In this case, an air volume in the receiving space 21 is displaced into the atmosphere A via the venting opening 24. The armature 13, which is attracted electromagnetically by the magnet core 12, also performs the lifting movement, so that, as a result, a second partial lift H2 of the armature 13 in the valve chamber 17 is realized. Here, the maximum opening width of the solenoid valve 10 is achieved and a fluidic connection between the first compressed-air port 15 and the second compressed-air port 16 is established, so that the inflowing compressed-air stream Lₑᵢₙ can be discharged into the atmosphere A via the second compressed-air port 16 as an outflowing compressed-air stream Lₐᵤₛ. In FIG. 1D, the coil is deenergized, so that the armature 13 is displaced back in the direction of the valve seat 18 with the assistance of the restoring device 22, and the sealing element 19 can close off the valve seat 18. The compressed air still situated in the armature guide 20 and the valve chamber 17 is vented substantially until pressure equalization, whereby the armature guide 20 and the magnet core 12 are displaced back into their original position with the assistance of the restoring element 21.

FIGS. 2A to 2D show, in each case in a sectional view, a pneumatic solenoid valve 10 according to a second embodiment. The pneumatic solenoid valve 10 according to the second embodiment is fundamentally comparable with the pneumatic solenoid valve 10 according to the first embodiment in terms of its general construction and its functioning. However, as FIGS. 2A to 2D show, according to the second embodiment of the pneumatic solenoid valve 10, it is provided that the receiving space 23 is closed and the magnet core 12 has a continuous central bore 25. A solenoid valve 10 according to the second embodiment is usable in particular for applications in which a working pressure above atmospheric pressure prevails at the second pressure port 16. Due to the closed receiving space 23, during a lifting movement of the magnet core 12, a build-up of pressure in the receiving space 23 that assists with resetting of the armature 13 by way of pressure equalization via the central bore 25 of the magnet core 12 when the coil is deenergized can be made possible. To facilitate the upward movement of the magnet core 12 into the receiving space 23, the receiving space 23 has a channel-like volume extension 29 with a cross-sectional reduction in relation to the receiving space 23.

The functioning of the pneumatic solenoid valve 10 according to the second embodiment will be explained in more detail below on the basis of the different states of the pneumatic solenoid valve 10 during activation and deactivation thereof that are shown in FIGS. 2A to 2D.

In FIG. 2A, the coil of the electromechanical actuator unit 11 is energized. Consequently, the armature 13 is attracted electromagnetically by the magnet core 12 and undergoes a first partial lift H1, which results in the sealing element 19 being lifted off from the valve seat 18, so that compressed air present at the first compressed-air port 15 can flow in as an inflowing compressed-air stream Lₑᵢₙ. It can be seen in FIG. 2B that the inflowing compressed-air stream Lₑᵢₙ increasingly fills an inner volume 20a of the armature guide 20, so that a build-up of pressure is realized. If the increasing pressure in the armature guide 20 exceeds a structurally predefinable minimum pressure, the armature guide 20, as shown in FIG. 2C, is raised and displaced into the receiving chamber 27. Owing to the magnet core 12 connected to the armature guide 20, the magnet core is also raised and is displaced into the receiving space 23. In this case, there is realized a build-up of pressure in the receiving space 23 by way of compression of an air volume contained in the receiving space 23. The armature 13, which is attracted electromagnetically by the magnet core 12, also performs the lifting movement, so that, as a result, a second partial lift H2 of the armature 13 in the valve chamber 17 is realized. Here, the maximum opening width of the solenoid valve 10 is achieved and a fluidic connection between the first compressed-air port 15 and the second compressed-air port 16 is established, so that the inflowing compressed-air stream Lₑᵢₙ can be discharged into the atmosphere A via the second compressed-air port 16 as an outflowing compressed-air stream Lₐᵤₛ. In FIG. 2D, the coil is deenergized, so that the armature 13 is displaced back in the direction of the valve seat 18 with the assistance of the restoring device 22 and the pressure, which is built up in the receiving space 23 and can act on the armature 13 via the central bore 25 in the magnet core 12, and the sealing element 19 can close off the valve seat 18. The compressed air still situated in the armature guide 20 and the valve chamber 17 is vented substantially until pressure equalization, whereby the armature guide 20 and the magnet core 12 are displaced back into their original position with the assistance of the restoring element 21.

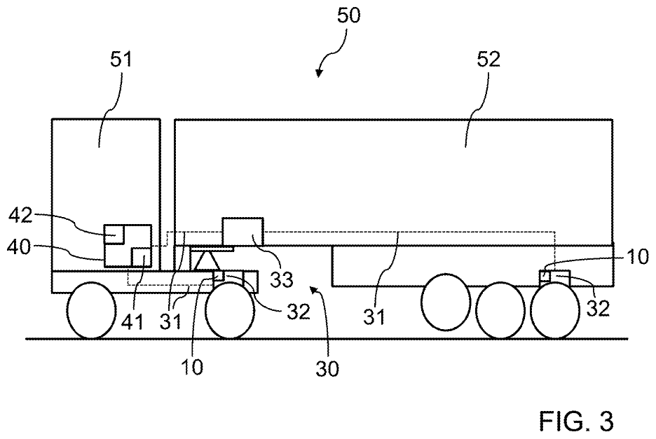

The above-described pneumatic solenoid valves 10 can advantageously be used in compressed-air systems 30 of vehicles 50. FIG. 3 shows a simplified schematic diagram of a vehicle 50 with a compressed-air system 30 having a pneumatic solenoid valve 10 in a side view. According to the illustration, the vehicle 50 is in the form of a vehicle combination including a towing vehicle 51 and a trailer vehicle 52. According to the embodiment shown, the compressed-air system 30 is configured as a pneumatic braking system. The compressed-air system 30 is supplied with compressed air, which may be stored temporarily for example in a compressed-air accumulator 33, by a compressed-air-supply device 40, which may have for example a compressor 41 and a controller 42, via compressed-air lines 31. For the purpose of decelerating the vehicle 50, compressed-air brakes 32 of the vehicle 50 can be supplied with compressed air and activated via further compressed-air lines 31. The compressed-air brakes 32 have at least one pneumatic solenoid valve 10 according to the above-described features in order, for example, to be able to aerate and/or vent a diaphragm cylinder of the compressed-air brakes 32. In this case, owing to the pneumatically self-energizing solenoid valve 10, large compressed-air streams can be controlled with a short reaction time and a low electrical energy requirement.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

10 Solenoid valve
11 Electromechanical actuator unit
12 Magnet core
13 Armature
14 Valve housing
14a Valve-housing surface
15 First compressed-air port
16 Second compressed-air port
17 Valve chamber
18 Valve seat
19 Sealing element
20 Armature guide
20a Inner volume of armature guide
21 Restoring element
22 Restoring device
23 Receiving space
24 Venting opening
25 Central bore
26 Sealing ring
27 Receiving chamber
28 Stop
29 Volume extension
30 Compressed-air system
31 Compressed-air line
32 Compressed-air brake
33 Compressed-air accumulator
40 Compressed-air-supply device
41 Compressor
42 Controller
50 Vehicle
51 Towing vehicle
52 Trailer vehicle
A Atmosphere
d Inlet diameter
E Plane of valve-housing surface
H1 First partial lift
H2 Second partial lift
Lₑᵢₙ Inflowing compressed-air stream
Lₐᵤₛ Outflowing compressed-air stream

1. A pneumatic solenoid valve comprising:
an electromechanical actuator unit having a coil, a magnet core, and a movable armature;
a valve housing having a first compressed-air port forming a compressed-air inlet and a second compressed-air port forming a compressed-air outlet;
a valve chamber having a valve seat at said first compressed-air port, wherein said valve seat is configured to be closed off via a sealing element arranged on said movable armature;
said electromechanical actuator unit having an armature guide in which said movable armature is movable in translation, wherein said armature guide is arranged movably in said valve housing and is connected to said magnet core; and,
the pneumatic solenoid valve being configured to effect, when said coil is energized, a first partial lift of said movable armature for lifting said sealing element off from said valve seat, and, by way of a compressed-air stream flowing in at said first compressed-air port, a lifting movement of said armature guide and said magnet core with a resulting second partial lift of said movable armature.

2. The pneumatic solenoid valve of claim 1, wherein the pneumatic solenoid valve is configured such that the second partial lift, configured to be effected via the compressed-air stream flowing in at said first compressed-air port, of said movable armature is larger than the first partial lift, configured to be effected via the energization of said coil, of said movable armature.

3. The pneumatic solenoid valve of claim 1, wherein said armature guide is configured, in an initial position, to be seated on a valve-housing surface which surrounds said valve seat and to receive the compressed-air stream inflowing in an inner volume of said armature guide.

4. The pneumatic solenoid valve of claim 1, wherein said valve seat is raised in relation to a plane of a valve-housing surface which surrounds said valve seat.

5. The pneumatic solenoid valve of claim 1, wherein the pneumatic solenoid valve is configured as a 2/2-way valve.

6. The pneumatic solenoid valve of claim 1 further comprising a restoring element configured to reset said magnet core and said armature guide.

7. The pneumatic solenoid valve of claim 1 further comprising a restoring device arranged in said armature guide and configured to reset said movable armature.

8. The pneumatic solenoid valve of claim 1, wherein a receiving space for receiving said magnet core during the lifting movement of said armature guide and said magnet core is arranged on a side of said magnet core that is remote from said movable armature.

9. The pneumatic solenoid valve of claim 8, wherein said receiving space is connected to an atmosphere via a venting opening.

10. The pneumatic solenoid valve of claim 8, wherein said receiving space is closed and said magnet core has a continuous central bore.

11. The pneumatic solenoid valve of claim 1, wherein a receiving chamber for receiving said armature guide during the lifting movement of said armature guide and of said magnet core is arranged adjoining said valve chamber.

12. The pneumatic solenoid valve of claim 1, wherein the pneumatic solenoid valve is for a compressed-air system of a vehicle.

13. A compressed-air system of a vehicle comprising:
a pneumatic solenoid valve including an electromechanical actuator unit, a valve housing, and a valve chamber;
said electromechanical actuator unit having a coil, a magnet core, and a movable armature;
said valve housing having a first compressed-air port forming a compressed-air inlet and a second compressed-air port forming a compressed-air outlet;
said valve chamber having a valve seat at said first compressed-air port, wherein said valve seat is configured to be closed off via a sealing element arranged on said movable armature;
said electromechanical actuator unit having an armature guide in which said movable armature is movable in translation, wherein said armature guide is arranged movably in said valve housing and is connected to said magnet core; and,
said pneumatic solenoid valve being configured to effect, when said coil is energized, a first partial lift of said movable armature for lifting said sealing element off from said valve seat, and, by way of a compressed-air stream flowing in at said first compressed-air port, a lifting movement of said armature guide and said magnet core with a resulting second partial lift of said movable armature.

13. A vehicle comprising:
a compressed-air system having a pneumatic solenoid valve including an electromechanical actuator unit, a valve housing, and a valve chamber;
said electromechanical actuator unit having a coil, a magnet core, and a movable armature;
said valve housing having a first compressed-air port forming a compressed-air inlet and a second compressed-air port forming a compressed-air outlet;
said valve chamber having a valve seat at said first compressed-air port, wherein said valve seat is configured to be closed off via a sealing element arranged on said movable armature;
said electromechanical actuator unit having an armature guide in which said movable armature is movable in translation, wherein said armature guide is arranged movably in said valve housing and is connected to said magnet core; and,
said pneumatic solenoid valve being configured to effect, when said coil is energized, a first partial lift of said movable armature for lifting said sealing element off from said valve seat, and, by way of a compressed-air stream flowing in at said first compressed-air port, a lifting movement of said armature guide and said magnet core with a resulting second partial lift of said movable armature.
